(19) United States
(12) Patent Application Publication
(10) Pub. No.: US 2024/0310081 A1
(43) Pub. Date: Sep. 19, 2024

(54) SYSTEM AND METHOD FOR GEOTHERMAL HEATING AND COOLING BASED ON ADVECTION

(71) Applicant: GENESYS US LLC, Chicago, IL (US)

(72) Inventor: Mandar Shridhar Kaprekar, Maharashtra (IN)

(21) Appl. No.: 18/672,847

(22) Filed: May 23, 2024

Related U.S. Application Data
(63) Continuation of application No. PCT/IN2022/051032, filed on Nov. 25, 2022.

(30) Foreign Application Priority Data
Nov. 25, 2021 (IN) 202121054521

(51) Int. Cl. F24T 10/30

(52) U.S. Cl. CPC F24T 10/30

(57) ABSTRACT

An advection based geothermal system is disclosed herein. The system comprises plurality of supply wells (200) situated below the ground level (GL); plurality of geothermal apparatus (300) within each of the supply wells (200); at least one diffusion well (600) for discharge of water received from the enclosure (1300); at least one auxiliary cooling apparatus (2100) within the enclosure (1300); and plurality of heat pumps (1100) connected to the geothermal apparatus (300) & the auxiliary cooling apparatus (2100) to provide cooling & heating within the enclosure (1300).

### FIELD OF INVENTION

The present invention generally relates to regulating temperature within an enclosure, such as a house, a building or such. The present invention particularly relates to a device and a system to provide heating or cooling to the enclosure using geothermal energy.

### BACKGROUND & PRIOR ARTS

Geothermal energy may be defined as a form of heat energy which originates from sub-surface of the earth, which may be utilized for heating and cooling applications. In general, geothermal energy systems utilize consistent subsurface temperature of the earth as a heat source in winter and as a heat sink in summer.

Having stated of systems employing geothermal energy, it generally means that such systems use subsurface rocks & sediments for heat exchange. However, WO2020117946 deals with a system which takes advantage of flowing or stationary water by having ground loops. The said system includes a groundwater heat exchanger within a borehole and exposed to a groundwater flow within an aquifer. An output pipe is provided to deliver the ground loop flow to the main heat exchanger through the groundwater heat exchanger.

The geothermal energy systems, that use heat energy associated with flowing or stationary water, is generally classified into open loop geothermal system and closed loop geothermal system. The open loop geothermal system may use ground water for transferring heat. The closed loop geothermal system may use a mix of antifreeze and water, which is made to cycle through pipes buried underground, instead of using the groundwater to transfer heat as in the case of open loop system. In both the systems, the pipes carrying water (along with the mix as the case may be) are eventually connected to the heat pump to achieve the desired effect in the give enclosure.

Even though the geothermal energy systems enable the heating and cooling applications, there exists a plurality of challenges associated with the geothermal energy systems. The closed loop geothermal system requires significantly large area for implementation, along with long pay back periods. Additionally, the closed loop geothermal systems has an associated piping loop which is buried underground. The nature of the closed loop system imposes limitations on the overall efficiency of the system. The efficiency of the closed loop geothermal systems may be related to various factors such as thermal conductivity of piping loop material, grout material, and ground strata. Poor thermal conductivity of the piping loop and requirement of a significant heat transfer area are also a matter of concern.

On the other hand, the open loop systems have their own limitations. Though open loop systems show better efficiency compared to the closed loop systems, contamination due to bacteria remains one of the major concerns. Some areas on the globe have scarce amount of water, which does affect the functionality of the open loop system. Furthermore, the extraction of the ground water above ground level is legally not permissible in some of the regions, which makes the open loop geothermal system inviable.

It may be noted that the geothermal systems are adopted in less than 1% cases due to high cost involved, large amounts of land requirement as well as issues of contamination due to bacteria. Hence, there is a need for an improved system and a method for geothermal heating and cooling based on advection to address the aforementioned issues.

### SUMMARY OF INVENTION

It is an object of the invention to regulate the temperature within an enclosure as per the need. It is a primary object of the invention to provide heating as well as cooling within the enclosure by the use of geothermal energy.

It is a further objective of the invention to provide temperature regulation geothermally in the enclosure that involves less space.

Accordingly, the present invention discloses advection based geothermal system adapted to provide cooling and heating within an enclosure.

The said system comprises plurality of supply wells adapted to draw groundwater for storage; plurality of geothermal apparatus within the supply wells configured to use geothermal energy the stored water; at least one diffusion well provided parallel to & lower than the supply wells configured to store discharged water; at least one auxiliary cooling apparatus within the enclosure to supplement the geothermal apparatus; and plurality of heat pumps connected to the geothermal apparatus & the auxiliary cooling apparatus.

In an embodiment, each of the said supply wells is configured to draw groundwater via a supply mechanism and an intake mechanism.

In an embodiment, each of said supply wells include a geothermal apparatus that assists advection based geothermal system for cooling or heating of the enclosure by means of the geothermal energy. The said apparatus comprises a heat exchangers unit adapted to receive a groundwater pipe and closed loop inlet & outlet pipes from & to an enclosure; a groundwater pumps unit connected in series with the heat exchangers unit by means of an inlet pipe; and a filtration unit around the groundwater pumps unit.

In an embodiment, the said apparatus is held to a position in the supply wells by means of a holding device. The said holding device has at least one fixed sling attached to one end of a pump sling holder by means of a fixed sling hook. The said holding device further includes at least one liftable sling attached to another end of the pump sling holder by means of a liftable sling hook.

In an embodiment, a pitless adapter unit is further provided for interconnecting the closed loop inlet & outlet pipes and the groundwater pipings. The said pitless adapter unit comprises; a first female fitting adapted to receive the closed loop inlet & outlet pipes; a second female fitting adapted to receive the groundwater piping, a first male fitting adapted to house the female fitting and a second male fitting adapted to house a drop pipe.

In an embodiment, the system is further provided with an installer device to assist in installing the geothermal apparatus. The installer device is included with a means to install the geothermal apparatus within the supply well. The installer device includes a clean-in-place unit and an antifreeze recovery unit.

The present invention alternately discloses advection based geothermal system adapted to provide cooling and heating within an enclosure, wherein the said system comprises of plurality of supply wells; plurality of geothermal apparatus within the supply wells; at least one diffusion well provided parallel to & lower than the supply wells; plurality of subsurface units situated placed outside the supply wells, wherein each of the subsurface unit is coupled to the geothermal apparatus, closed loop inlet & outlet pipes, and the diffusion well; at least one auxiliary cooling apparatus within the enclosure; and plurality of heat pumps connected to the geothermal apparatus & the auxiliary cooling apparatus.

In yet another embodiment, the present invention discloses an advection based movable geothermal system, which is configured to be used when there is an availability of surface water body, such as pond, lake etc. The said system comprises of a cannon unit, an inline valve box, and a trench bundle. The cannon unit is provided with at least one pair of wheels enabling to move in or out of the surface water.

### BRIEF DESCRIPTION OF DRAWINGS

Following figures illustrate at least one preferred embodiment of the invention and various components associates with it.

FIG. 1 illustrates a schematic representation of the advection based geothermal system.

FIG. 1A illustrates a schematic representation of the system as an alternate embodiment.

FIG. 2 illustrates a geothermal apparatus (300) which is a part of the system illustrated in FIG. 1.

FIG. 3 illustrates a configuration connecting the supply wells (200).

FIG. 4(a) illustrates a pitless adapter apparatus (PAU10).

FIG. 4(b) illustrates a pitless adapter unit (220).

FIG. 5 illustrates a sectional view of the pitless adapter unit (220).

FIG. 6 illustrates a holding device (250) for holding the geothermal apparatus (300) inside the supply well (200).

FIG. 7 illustrates a filtration unit (316) provided for the geothermal apparatus (300).

FIG. 8 illustrates an installer device (340) to install the geothermal apparatus (300) inside the supply well (200).

FIG. 9 illustrates a clean-in-place unit (380).

FIG. 10 illustrates an antifreeze recovery unit (390).

FIG. 11 illustrates an auxiliary cooling apparatus (2100) support the geothermal apparatus (300).

FIG. 12a illustrates alternative form of the advection based movable system.

FIG. 12b illustrates a cannon unit (2260), which is a part of the system depicted in FIG. 12a.

FIG. 12c illustrates a valve box (2205) of the system depicted in FIG. 12a.

### DETAILED DESCRIPTION OF THE INVENTION

Accordingly, the present invention discloses an advection based geothermal system, wherein the said system is adapted to provide cooling and heating within an enclosure using geothermal energy. As a consequence, the system will prove to be power saving in terms of electric energy. The system does not do away with use of electricity but reduces its use due to its unique working The present invention further discloses a geothermal apparatus to assist advection based geothermal system.

The present invention further discloses a holding device to hold an apparatus inside a supply well of the advection based geothermal system.

The present invention further discloses a pitless adapter unit configured to connect the groundwater piping as well as the closed loop inlet & outlet pipes in an advection based geothermal system.

The present invention even further discloses an installer device for assisting in installing a geothermal apparatus.

The invention is described herein in detail with the help of figures appended at the end of the specification. The figures illustrate the preferred embodiment as well as other embodiments that define the scope of the present invention. However, it may be understood that the figures presented herein are intended to exemplify the scope of the invention only. The person skilled in art may note that by no means the figures limit the scope of the invention. Any variation in the drawings by any other person will be falling in the scope of the present invention.

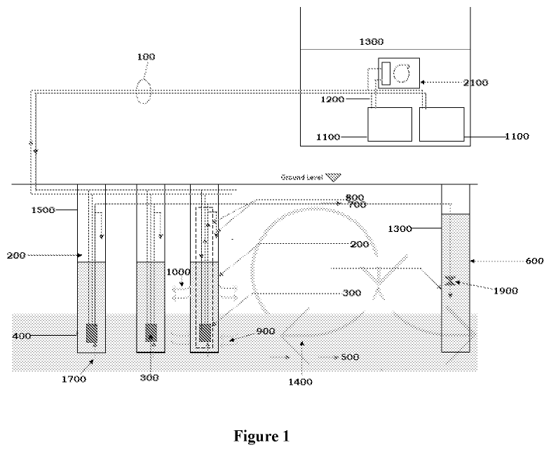

FIG. 1 illustrates a schematic representation of the advection based geothermal system. The system comprises plurality of supply wells (200) situated below the ground level (GL) and adapted to receive groundwater source (400); plurality of geothermal apparatus (300), each provided within each of the supply wells (200), adapted to exchange heat between the enclosure (1300) & the groundwater source (400); at least one diffusion well (600) provided parallel to & lower than the supply wells (200) for discharge of water received from the enclosure (1300); at least one auxiliary cooling apparatus (2100) within the enclosure (1300) adapted to receive groundwater from the geothermal apparatus (300) and precool return air from the enclosure (1300) to plurality of heat pumps (1100); and plurality of heat pumps (1100) connected to the geothermal apparatus (300) & the auxiliary cooling apparatus (2100) to provide cooling & heating within the enclosure (1300).

The system provides heating or cooling effect to the enclosure by use of the groundwater sources, such as any aquifer. The supply well (200) takes in the groundwater from the aquifer and pushes the groundwater through the geothermal apparatus. The groundwater exchanges heat with the closed loop connected to the other side of the geothermal apparatus. After exchanging heat, the groundwater is transported to the diffusion well (600), where the water is diffused back to the aquifer.

In the context of the present invention, the term “enclosure” means any closed space which is to be provided with a heat or cold as per the requirement. Such closed space may be a room, a house or a building, utilised for commercial or residential purposes. There is no limit to the area of the “enclosure”. The present invention is adapted to provide heating or cooling effect to the enclosure, irrespective of its area, with tweaking in system's dimensions as per the requirement.

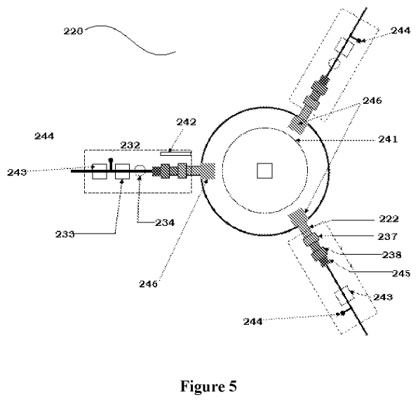

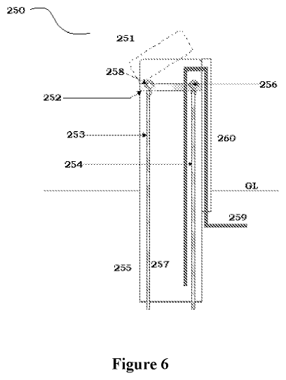

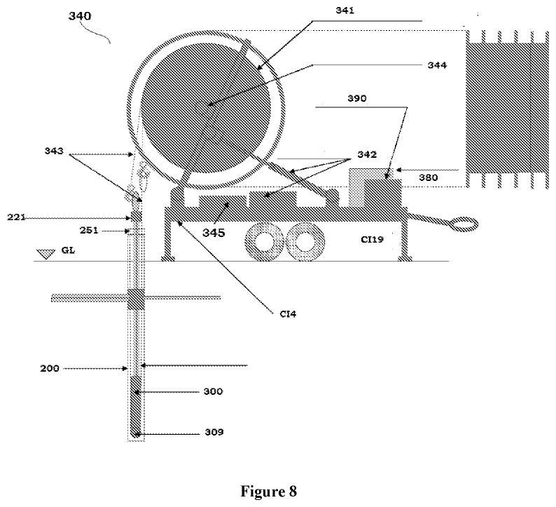

In a preferred embodiment, each of the supply wells (200) is configured to draw groundwater via a supply mechanism (1700) & an intake mechanism (900). In an embodiment, the supply wells (200) are placed either in sequential manner or in parallel. In a working embodiment, the supply mechanism (1700) and an intake mechanism (900) may be a combination of the pumps by which groundwater may be drawn into the supply wells (200). Further, the arrangement of the plurality of supply wells (200) depends upon the system requirement, which includes factors such as load. In a preferred embodiment, the discharge well (600) is provided with a cracking pressure valve (1900), which ensures that there is no air intake inside the diffusion loop, eliminating the possibility of the bacteria growth in the system. As stated before, each of the supply well (200) includes at least one geothermal apparatus (300), wherein the geothermal apparatus (300) is held into the supply well (200) by means of a holding device (250) (FIG. 6). Further, the geothermal apparatus (300) is installed in the supply wells (200) by means of an installer device (340) (FIG. 8).

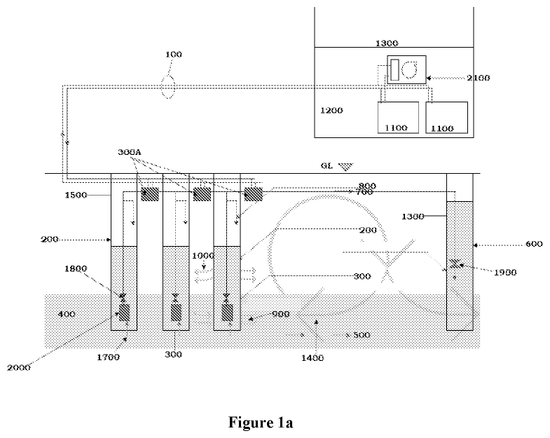

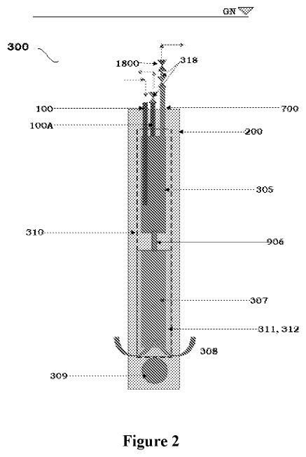

FIG. 2 represents the geothermal apparatus (300), which is configured to assist the advection based geothermal system. The geothermal apparatus (300) comprises of a heat exchangers unit (305) adapted to receive a groundwater pipe (700) & closed loop inlet & outlet pipes (100) from & to an enclosure and towards a diffusion well (600); a groundwater pumps unit (307) connected in series with the heat exchangers unit (305) by means of an inlet pipe (306); and a filtration unit (316) around the groundwater pumps unit (307).

The geothermal apparatus (300) plays a crucial part in the working of the present system. The heat exchanger unit (305) includes a plurality of heat exchangers stacked together to meet the system requirement. The plurality of heat exchangers tend to enhance the capacity of the system to heat or cool the enclosure. The heat exchanger unit (305) utilise the thermal energy of the water received in the supply wells (200) for providing heat or cold to the enclosure (1300) through the closed loop inlet pipes from & to the enclosure (1300). Further, the water received through the closed loop outlet pipes by the geothermal apparatus (300) is discharged in the diffusion well (600).

Within the apparatus, the heat exchangers unit (305) and the groundwater pumps unit (307) are encased in a covering (310). Further, a pair of constant flow valves (318) is provided for water flow regulation towards the groundwater pipe (700) and the closed loop inlet & outlet pipes (100).

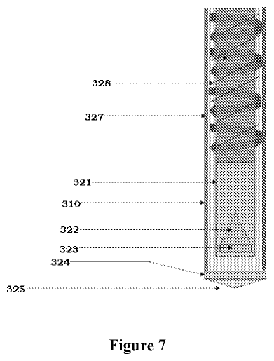

The filtration unit (316), configured to reduce possibility of contamination of stored water, provided in the geothermal apparatus (300) is illustrated in FIG. 7. Accordingly, the filtration unit (316) comprises of plurality of sieves (327) & slots (328) provided at the middle portion of the apparatus (300); a suction tube (321) below said plurality of sieves (327) & slots (328); a slider cone (322) below the suction tube (321); a suction gate plate (323) below the slider cone (322); a collector (324) below the suction gate plate (323); and an aperture (325) below the collector (324).

FIG. 6 illustrates the holding device (250) adapted to hold the geothermal apparatus (300) in the supply well (200). The holding device comprises a well cap (251) at a top end of the holding device (250); at least one pump sling holder (252); at least one fixed sling (253) attached to one end of the pump sling holder (252) by means of a fixed sling hook (258); and at least one liftable sling (254) attached to another end of the pump sling holder (252) by means of a liftable sling hook (256).

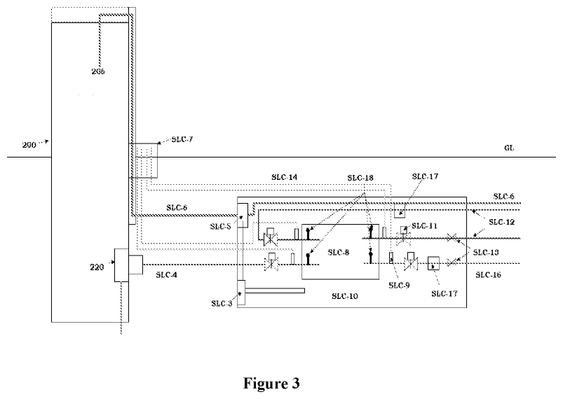

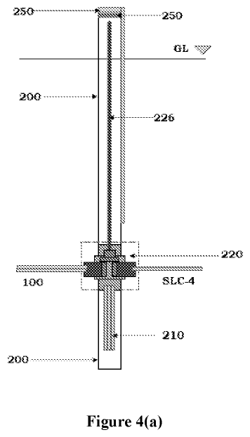

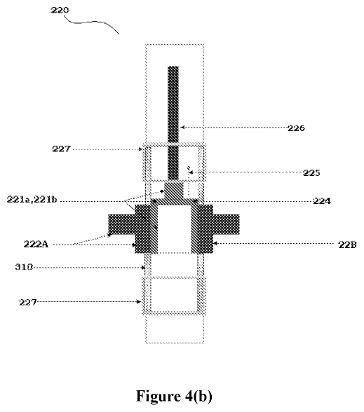

FIG. 4(a) illustrates the position of the pitless adapter unit (220) in the supply well (200), whereas FIG. 4(b) illustrates the composition of the pitless adapter unit (220). The pitless adapter unit (220) is configured to connect the groundwater piping (700) as well as the closed loop inlet & outlet pipes (100) and comprises of a first female fitting (222-A) adapted to receive the closed loop inlet & outlet pipes (100); a second female fitting (222-B) adapted to receive the groundwater piping (700); a first male fitting (221a) adapted to house the female fitting (222A) and a second male fitting adapted to house a drop pipe (226).

As shown in FIG. 5, each of the female fitting (222-A,222-B) comprises at least one union joint (237), at least one expander fitting (238), and at least one barb fitting (245). Each of the female fitting (222-A,222-B) further comprises of at least one flow meter (243), and at least one temperature sensor (244). The pitless adapter unit (220) is further provided with a port (234) for assisting recovery of anti-freeze composition.

The installer device (340) configured to assist in installing the geothermal apparatus (300) in the supply wells (200) in illustrated in FIG. 8. The installer device (340) for assisting in installing a geothermal apparatus (300) comprises: a spool (341) for winding cables, slings and such; at least one spool mover (342); plurality of slings (343); a power supply unit (345); a clean-in-place unit (380); and an anti-freeze recovery unit (390).

FIG. 9 illustrates the clean-in-place unit (380) configured to clean interiors of the installer device (340). The clean-in-place unit (380) comprises a cleaning fluid storage tank (386); a recirculatory pump (384); a CIP filter (389) coupled to the cleaning fluid storage tank (386) through an isolation valve (383).

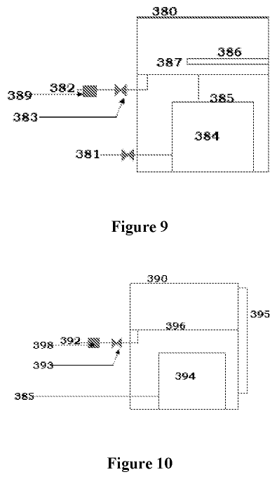

The antifreeze recovery unit (390) is configured to collect the expanding antifreeze composition, and to recycle back in the system once the composition loses adequate heat. Such antifreeze composition act as a coolant while providing cooling effect in the system. As shown in FIG. 10, the antifreeze recovery unit (390) comprises an antifreeze composition storage tank (396); a recovery pump (394); a recovery filter (398) coupled to the antifreeze composition storage tank (396) through an isolation valve (393).

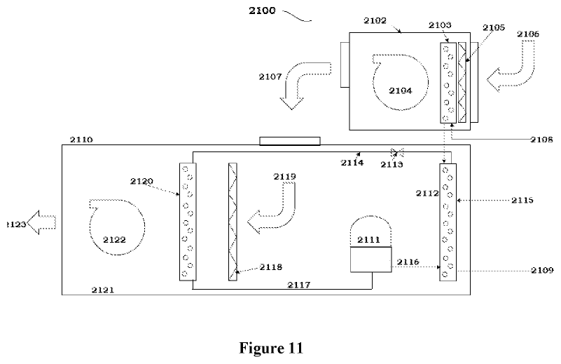

FIG. 11 illustrates the auxiliary cooling unit (2100) communicatively coupled with the heat pumps (1100). The auxiliary cooling unit (2100) inhales the return air (2106) from the enclosure (1300) that passes through an air filter (2105), and the auxiliary heat exchanger (2103) configured to cool this air. The rotating fan (2104) circulates and exhales the pre-cooled air towards the heat pump (1100) that cools down the air further.

In an alternate embodiment, the system comprises plurality of supply wells (200) below the ground level (GL) adapted to receive groundwater source (400); at least one pump (2000) provided in each of the supply wells (200); at least one diffusion well (600) provided parallel to & lower than the supply wells (200) for a discharge of the water received from the enclosure (1300); plurality of subsurface unit (300A) situated outside the supply wells (200) and configured to connect said pump (2000) to said diffusion well (600); at least one auxiliary cooling apparatus (2100) within the enclosure (1300) adapted to receive groundwater from the geothermal apparatus (300) and precool return air from the enclosure (1300) to heat pumps (1100); and plurality of heat pumps (1100) connected to the geothermal apparatus (300) & the auxiliary cooling apparatus (2100) to provide cooling & heating within the enclosure (1300).

In this particular embodiment, the subsurface unit (300A) is communicatively coupled with a cracking pressure valve (1900) placed in the diffusion well (600). The subsurface unit (300A) is configured to utilise geothermal energy of subsurface elements, such as soil or rock or such. The said alternate embodiment of the system thus utilises geothermal energy of the subsurface elements in addition to the groundwater with the help of the geothermal apparatus (300).

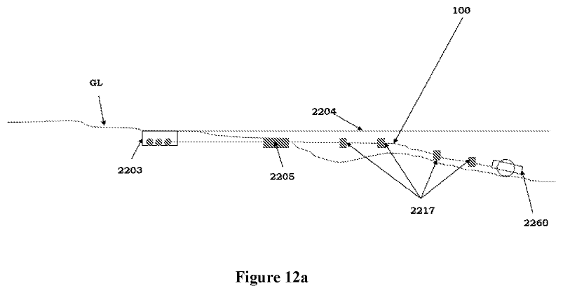

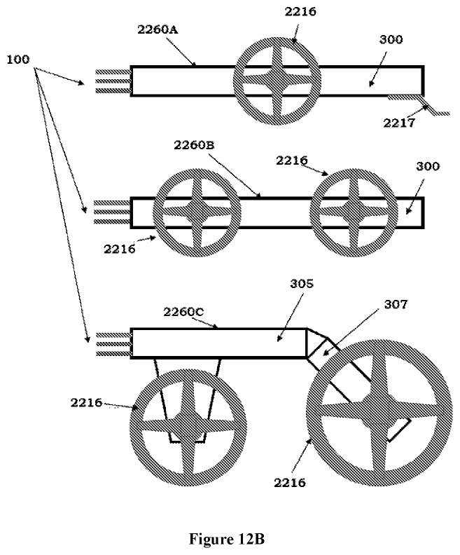

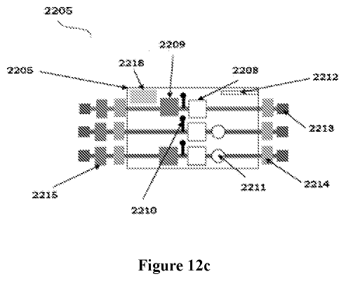

FIG. 12a and FIG. 12b show the alternative form of the advection based geothermal system. This form is employed when the water source is a surface water body, such as a lake, a pond, a river or any such source. The said movable system comprises of a cannon unit (2260), an inline valve box (2205), and a trench bundle (2203). The cannon unit (2260) is submerged in surface water bodies (2204) and is connected with the pipes buried in the trench (2203) via a set of three flexible pipes (100). The flexible pipes (100) are analogous to a set of the pipes (100) depicted in FIG. 1. The pump cables are connected by binding clips (2217). The cannon unit (2260) is connected to a puller sling (254) to pull the cannon unit (2260) out of the surface water body (2204).

The water from the surface water body (2204) is released back to the surface water body at one or more outfalls at least 50 feet away from the site of intake after exchanging heat. In this case, the outfalls are similar to the diffusion wells (600) depicted in FIG. 1. However in contrast to the system depicted in FIG. 1, the supply wells (200) and the diffusion well (600) are not required in the system depicted in FIG. 12, since the water is drawn from a surface water body. Similar to preferred embodiment and alternate embodiment described previously, the trench (2203) connects to the building.

The cannon unit (2260) is provided with at least one pair of wheels (2216) in various configurations illustrated in FIG. 12b, for the purpose of pulling or pushing the cannon unit (2260) from or into a surface water body (2204). The pipe bundle is connected to a valve box (2205) along the shoreline, which is usually located outside the water body.

FIG. 12c illustrates the valve box (2205), wherein the valve box (2205) is a semi-hermetic box with gaskets to keep water away from internal components. The valve box (2205) is provided with a barb fittings (2213), at least one union joint (2214), at least one expander fitting (2215), a flow meter (2209), at least one temperature sensor (2210), at least one motorized isolation valve (2208), at least one antifreeze composition recovery port (2211), and a heater element and an air temperature sensor (2212). In this embodiment, the expander fitting (2215) assists in the transition from one pipe diameter to another. The union joints (2214) is adapted to decouple the cannon unit (2260) from the valve box (2205) or the trench commoner pipes (2203). The barb fittings (2213) provided on both sides of the valve box (2205) is configured to connect flexible pipes (100) to the valve box (2205). Before opening or disconnecting the valve box (2205), the motorized valves (2208) are charged from an external power source. The valve box (2205) has access (2218) for connecting to an external power supply, and a portable monitoring device that reads the flow meters' (2209) and the temperature sensors' (2210) values. The antifreeze composition recovery ports (2211) may be connected to the recovery unit (390) for glycol or comparable fluid recovery or addition to the system. Once the isolation valves (2208) are turned off, the recovery ports (2211) may be opened.

The configuration and arrangement within the system is unique vis-à-vis existing geothermal systems. The configuration of the system enhances its functioning by at least 50% compared to that of the prior art. The increased efficiency is not just for the system, but with each of the supply well also. The inventor has figured out through data that the land requirement for working of the system is at least 80% less than that of the existing systems. Reduced cost is another advantage, wherein the present system requires half of the cost for that of the existing systems.

We claim:

1. An advection based geothermal system adapted to provide cooling and heating within an enclosure (1300) comprises:
plurality of supply wells (200) situated below the ground level (GL) and adapted to receive groundwater source (400);
plurality of geothermal apparatus (300), each provided within each of the supply wells (200), adapted to exchange heat between the enclosure (1300) & the groundwater source (400);
at least one diffusion well (600) provided parallel to & lower than the supply wells (200) for discharge of water received from the enclosure (1300);
at least one auxiliary cooling apparatus (2100) within the enclosure (1300) adapted to receive groundwater from the geothermal apparatus (300) and precool return air from the enclosure (1300) to heat pumps (1100); and
plurality of heat pumps (1100) connected to the geothermal apparatus (300) & the auxiliary cooling apparatus (2100) to provide cooling & heating within the enclosure (1300).

2. The system as claimed in claim 1, wherein each of the supply wells (200) is configured to draw groundwater via a supply mechanism (1700) & an intake mechanism (900).

3. The system as claimed in claim 1, wherein each of the geothermal apparatus (300) is configured to receive closed loop inlet & outlet pipes (100) from & to the enclosure (1300).

4. The system as claimed in claim 1, wherein each of the geothermal apparatus (300) is included in each of the supply wells (200) by means of a holding device (250).

5. The system as claimed in claim 1, wherein the system is further provided with an installer device (340) to assist in installing the geothermal apparatus (300).

6. The system as claimed in claim 1, wherein water from each of the supply wells (200) is discharged into the diffusion well (600) by means of a groundwater piping (700).

7. The system as claimed in claim 1, wherein the diffusion well (600) is provided with a cracking pressure valve (1900).

8. The system as claimed in claim 1, wherein at least one pitless adapter unit (PAU1) is provided in each of the well (200) for connecting the groundwater piping (700) as well as the closed loop inlet & outlet pipes (100).

9. A geothermal apparatus (300) to assist advection based geothermal system comprises:
a heat exchangers unit (305) adapted to receive a groundwater pipe (700) & closed loop inlet & outlet pipes (100) from & to an enclosure and towards a diffusion well (600);
a groundwater pumps unit (307) connected in series with the heat exchangers unit (305) by means of an inlet pipe (306); and
a filtration unit (316) around the groundwater pumps unit (307); wherein the apparatus (300) is situated inside a supply well (200) below a ground level (GL).

10. The apparatus (300) as claimed in claim 9, wherein a pulley (309) is provided at a bottom of the groundwater pumps unit (307).

11. The apparatus (300) as claimed in claim 9, wherein the heat exchangers unit (305) and the groundwater pumps unit (307) are encased in a covering (310).

12. The apparatus (300) as claimed in claim 9, wherein a pair of constant flow valves (318) is provided for water flow regulation towards the groundwater pipe (700) and the closed loop inlet & outlet pipes (100).

13. The apparatus (300) as claimed in claim 9, wherein the filtration unit (316) comprises:
plurality of sieves (327) & slots (328) provided at a middle portion of the apparatus (300);
a suction tube (321) below said plurality of sieves (327) & slots (328);
a slider cone (322) below the suction tube (321);
a suction gate plate (323) below the slider cone (322);
a collector (324) below the suction gate plate (323); and
an aperture (325) below the collector (324).

14. A holding device (250) to hold an apparatus (300) inside a supply well (200) comprises:
a well cap (251) at a top end of the holding device (250);
at least one pump sling holder (252);
at least one fixed sling (253) attached to one end of the pump sling holder (252) by means of a fixed sling hook (258); and
at least one liftable sling (254) attached to another end of the pump sling holder (252) by means of a liftable sling hook (256).

15. A pitless adapter unit (220) configured to connect the groundwater piping (700) as well as the closed loop inlet & outlet pipes (100) in an advection based geothermal system comprises a first female fitting (222-A) adapted to receive the closed loop inlet & outlet pipes (100); a second female fitting (222-B) adapted to receive the groundwater piping (700); a first male fitting (221a) adapted to house the female fitting (222A) and a second male fitting adapted to house a drop pipe (226).

16. The pitless adapter unit (220) as claimed in claim 15, wherein each of the female fitting (222-A,222-B) comprises at least one union joint (237), at least one expander fitting (238), and at least one barb fitting (245).

17. The pitless adapter unit (220) as claimed in claim 15, wherein each of the female fitting (222-A,222-B) further comprises of at least one flow meter (243), and at least one temperature sensor (244).

18. The pitless adapter unit (220) as claimed in claim 15, wherein the pitless adapter unit (220) is further provided with a port (234) for assisting recovery of anti-freeze composition.

19. An installer device (340) for assisting in installing a geothermal apparatus (300) comprises: a spool (341); at least one spool mover (342); plurality of slings (343); a power supply unit (345); a clean-in-place unit (380); and an anti-freeze recovery unit (390).

20. The installer device (340) as claimed in claim 19, wherein the clean-in-place unit (380) comprises a cleaning fluid storage tank (386); a recirculatory pump (384); a CIP filter (389) coupled to the cleaning fluid storage tank (386) through an isolation valve (383).

21. The installer device as claimed in claim 19, wherein the antifreeze recovery unit (390) comprises an antifreeze composition storage tank (396); a recovery pump (394); a recovery filter (398) coupled to the antifreeze composition storage tank (396) through an isolation valve (393).

22. An advection based geothermal system adapted to provide cooling and heating within
an enclosure (1300) based on geothermal energy comprises:
plurality of supply wells (200) below the ground level (GL) adapted to receive groundwater source (400);
at least one pump (2000) provided in each of the supply wells (200);
at least one diffusion well (600) provided parallel to & lower than the supply wells (200) for a discharge of the water received from the enclosure (1300);
plurality of subsurface unit (300A) situated outside the supply wells (200) and configured to connect said pump (2000) to said diffusion well (600);
at least one auxiliary cooling apparatus (2100) within the enclosure (1300) adapted to receive groundwater from the geothermal apparatus (300) and precool return air from the enclosure (1300) to heat pumps (1100); and
plurality of heat pumps (1100) connected to the geothermal apparatus (300) & the auxiliary cooling apparatus (2100) to provide cooling & heating within the enclosure (1300).

23. The system as claimed in claim 22, wherein the subsurface unit (300A) is communicatively couple to a cracking pressure valve (1900) placed in the diffusion well (600).

24. An advection based movable geothermal system configured to be used during availability of a surface water body comprises a movable cannon unit (2260) submerged in the surface water body, an inline valve box (2205), and a trench (2203) placed outside the surface water body joined with the movable cannon unit (2260) through the valve box (2205).

25. The system as claimed in claim 24, wherein the cannon unit (2260) is provided with at least one pair of wheels (2216).

26. The system as claimed in claim 24, wherein the valve box (2205) comprises a barb fittings (2213), at least one union joint (2214), at least one expander fitting (2215), a flow meter (2209), at least one temperature sensor (2210), at least one motorized isolation valve (2208), at least one antifreeze composition recovery port (2211), and a heater element and an air temperature sensor (2212).
